(19) United States
(12) Patent Application Publication
(10) Pub. No.: US 2014/0306576 A1
(43) Pub. Date: Oct. 16, 2014

(54) Surface Vibration Using Compliant Mechanical Amplifier

(71) Applicants: James D. Ervin, Novi, MI (US); Dragan Maric, Ann Arbor, MI (US); Gregory F. Ervin, Canton, MI (US); Sridhar Kota, Ann Arbor, MI (US); Joel A. Hetrick, Ann Arbor, MI (US)

(72) Inventors: James D. Ervin, Novi, MI (US); Dragan Maric, Ann Arbor, MI (US); Gregory F. Ervin, Canton, MI (US); Sridhar Kota, Ann Arbor, MI (US); Joel A. Hetrick, Ann Arbor, MI (US)

(73) Assignee: FlexSys, Inc., Ann Arbor, MI (US)

(21) Appl. No.: 14/135,573

(22) Filed: Dec. 19, 2013

Related U.S. Application Data
(63) Continuation of application No. 12/450,796, filed on May 17, 2010, now abandoned.
(60) Provisional application No. 60/923,233, filed on Apr. 13, 2007.

(51) Int. Cl. H02N 2/00; F16F 7/00; F16F 15/00; F16F 15/04

(52) U.S. Cl. CPC H02N 2/001; F16F 15/04; F16F 7/00; F16F 15/005
USPC 310/323.01; 74/96; 267/136; 267/140.11

(57) ABSTRACT

A displacement amplifier receives an actuation displacement signal from a piezoelectric actuator. The displacement signal is amplified by one or more stages of compliant elements, and a corresponding force is applied to a load. Wide frequency response is achieved in response to the resilience characteristics of the compliant elements that are formed from any of several materials, illustratively aluminum, steel, titanium, plastics, composites, etc., and are produced by any of several manufacturing techniques, illustratively extrusion, die casting, forging, etc. The compliant elements can be configured as plural compliant mechanical displacement amplifier stages. In bilateral arrangements displacement signals from distal ends of the motive source are applied to symmetrical, or mirror image, arrangements of compliant elements. The motive source, which may be a piezoelectric actuator, delivers its displacement signal at one end thereof to one or more compliant elements. The other end of the piezoelectric actuator can be grounded.

### CROSS-REFERENCE TO RELATED APPLICATIONS

This application is a continuation of U.S. Ser. No. 12/450,796 filed on May 17, 2010 as the US national stage filing under 35 U.S.C. §371 of International Application No. PCT/US08/04871 filed on Apr. 14, 2008 and claims the benefit under 35 U.S.C. §119(e) of U.S. Provisional Patent Application Ser. No. 60/923,233 filed Apr. 13, 2007. The disclosures in these applications are incorporated herein by reference.

### BACKGROUND OF THE INVENTION

1. Field of the Invention

This invention relates generally to mechanisms that receive a displacement or force applied by an actuator and that deliver a modified displacement or force to a load, and more particularly, to a structure that employs elastically deformable elements that are coupled to each other generally without the use of pivot couplings and that deliver to the load a predetermined force/displacement characteristic.

2. Description of the Prior Art

There is known in the prior art a core structure that relies on the elastic deformation of its constituent elements to transmit forces and motion from an input to an output. This known type of structure is disclosed in U.S. Pat. No. 6,557,436, the disclosure of which is incorporated herein by reference, and relates to the field of microelectromechanical (MEM) systems. In the known arrangement, a structure is formed without pivot couplings by surface micromachining processes for use in combination with a MEM actuator (such as an electrostatic comb actuator, a capacitive-plate electrostatic actuator) or a thermal actuator to modify a displacement or force provided by the MEM actuator.

FIG. 1 illustrates a base prior art displacement amplifying structure, generally designated as structure 10. As shown, known structure 10 is configured to have a generally triangular form that is defined by three legs and that is supported by a base 12, ground, or substrate. The first leg of the known triangular form is defined by a beam 14 that has a fixed or anchored end 16 and a moveable end 18. Beam 14 is referred to herein as “static beam 14,” the term “static” being used as a result of the end 16 being anchored. However, beam 14 is not “static” in the traditional sense of the term because it includes a moveable end 18 and additionally because the beam 14 is flexible.

The second leg of the base structure's triangular form is defined by a beam that hereinafter is referred to as “dynamic beam 20.” Dynamic beam 20 includes a first or input end 22 and a second or output end 24. This beam 20 is herein referred to as a “dynamic beam” because its input end 22 is coupled to an actuator 26, that may be of any variety of motive force source including, by way of illustration and not limitation, piezoelectric actuators, thermal actuators, SMA actuators, capacitive-plate electrostatic actuators, electrostatic comb actuators, pneumatic actuators, hydraulic actuators, or mechanical actuator systems.

The output end 24 of dynamic beam 20 is connected to moveable end 18 of static beam 14 in a pivotless or jointless connection, i.e., excluding utilization of hinges, flexural joints, living hinges, and pivots for the connection between static beam 14 and dynamic beam 20. Preferably, static and dynamic beams 14 and 20 of structure 10 are formed together in a unitary construction.

In accordance with the description of this known arrangement in U.S. Pat. No. 6,557,436, the third leg of the base structure's triangular form is an imaginary leg defined by base 12 and extending between fixed end 16 of static beam 14 and input end 22 of dynamic beam 20.

When actuator 26 imparts an input displacement X to input end 22 of dynamic beam 20, beams 20 and 14 will flex as a result of the anchoring of fixed end 16 of static beam 14 and the elasticity characteristics of beams 14 and 20 themselves. As a result of the prescribed construction, the output displacement Y, measured as the movement of output 28, will be greater than the input displacement X. Additionally, when the input displacement X is generally in the direction of the apex formed by the connection of the static beam 14 with the dynamic beam 20, the direction of the output displacement Y will generally be transverse or perpendicular to the direction of the apex. The displaced or flexed position of the structure 10 is generally illustrated in phantom in FIG. 1.

It is additionally known from the prior art that upon the joining of two or more base structures 10, the output displacement Y from the last of the structures 10 in the series can be designed to achieve a desired amplitude ratio (Y/X). Three structures 10 are illustrated in prior art device 11 shown in FIG. 2. (Generally throughout this description of the prior art device the term “structure 10” is used to identify one triangular form while the term “device 11” is used to designate a series of structures 10. The terms, however, are generally interchangeable throughout this description and in the claims (where appropriate). It is noted that in forming a device from a series of the structures 10, the input end 22 of each successive dynamic beam 20 is connected to the output 28 of the immediately proceeding structure, the output being defined where the static and dynamic beams 14 and 20 are joined or merged together. For the sake of clarity, the output of the structure 10 or device 11 is generally designated at 28 in FIG. 1. Notably in FIG. 2, the known configuration results in the direction of the output displacement Y being generally in an opposite direction than that illustrated in FIG. 1.

In comparing the forces transmitted by the structure 10 and device 11, it is noted that when driven as described above, the input force provided by the actuator 26 is changed and at the output end 28 of the structure the output force is decreased relative to the input force. For an ideal structure 10 or device 11, the output force times the output displacement would be equal to the input force times the input displacement. However, some losses will occur during transmission through the structure 10 or device 11. Actual structures 10 and devices 11 have been realized where the output force times the output displacement is generally equal to about 70%-90% of the input force times the input displacement.

It is seen from the foregoing that a series of the structures 10 designed and arranged with the interconnecting of their respective beams 14 and 20 can provide a predetermined geometric advantage and a predetermined mechanical advantage. The geometric advantage is herein defined as the ratio of an output displacement generated by the structure 10 or the device 11 in response to a given input displacement. The mechanical advantage is defined herein as the ratio of an output force generated by the structure 10 or device 11 in response to the input force.

FIG. 3 schematically illustrates a prior art topology where a compactly constructed device 311 is formed about a linear actuator 26 so as to provide a linear output designated by directional arrow 38. The known topology in FIG. 3 illustrates how known structures 10 can be arranged so as to form a device 311 by generally encircling linear actuator 26. With this topology, which is shown to consist of six structures 10, the outputs of the individual structures is transferred clockwise about device 311, by locating the static beams 14 interiorly of the dynamic beams 20, until the last structure 10, which is shown to have a reversed orientation.

In FIG. 4, it is seen that the single input displacement X can be applied to a series of known structures 10 forming a device 211, with the topology of the series of structures being configured such that the device 211 is formed of two mirrored halves 34 and 34′. Such a known configuration may be utilized to provide the output displacement Y of the output members 32 generally along the axis 30 of the input displacement X. Further, output members 32 from each half 34 and 34′ are shown to be joined by a cross-member 36 to provide for a single output displacement and force. Device 211 of FIG. 7 is formed of structures 10, with four structures 10 being utilized to define each half 34 and 34′. The known device represented in this figure is indicated to provide a 14:1 geometric advantage.

With the foregoing in mind, it is an object of this invention to provide a motion amplifier that can easily be manufactured.

It is also an object of this invention to provide a motion amplifier that readily can be manufactured with minimum thickness variation.

It is additionally an object of this invention to provide a motion amplifier that exhibits reduced complexity over known motion amplifier systems.

It is a further object of this invention to provide a motion amplifier that achieves improved low-frequency performance.

It is yet another object of this invention to provide a motion amplifier that achieves higher amplification at a lower natural frequency so as to achieve improved low-frequency performance.

It is a still further object of this invention to provide a motion amplifier that minimizes the effects of lower-order modes to ensure improved consistency in its response characteristics.

### SUMMARY OF THE INVENTION

The foregoing and other objects are achieved by this invention which provides a motion transducer having a base member, the base member having a longitudinal axis. A first compliant transducer arrangement is installed on the base member, the first compliant transducer arrangement having an input for receiving a first input displacement directed substantially parallel to the longitudinal axis of the base member and an output for producing a first output force directed at a predetermined angle with respect to the longitudinal axis of the base member. There is additionally provided an actuator element having a first output portion coupled to the input of the first compliant transducer arrangement for producing the first input displacement.

In one embodiment of the invention, there is further provided a second compliant transducer arrangement installed on the base member. The second compliant transducer arrangement has an input for receiving a second input displacement and an output for producing an output force directed at a further predetermined angle with respect to the longitudinal axis of the base member. The actuator element has a second output portion coupled to the input of the second compliant transducer arrangement for producing the second input displacement.

In some embodiments, the first and second output forces are directed so as to be parallel to each other. In other embodiments, however, the first and second output forces are directed at respective different angles with respect to the longitudinal axis of the base member.

In embodiments of the invention where the first compliant transducer arrangement is formed of first and second triangular structure, there is provided a further base member that is displaced relative to the base member for coupling to the first triangular structure of the first compliant transducer arrangement, but which in some embodiments of the invention is fixed in relation to the base member. Each of the first and second triangular structures is provided with an output for producing a respective component of the first output force. Also, the outputs of the first and second triangular structures are, in some embodiments, substantially parallel to each other.

In a still further embodiment, there is provided a further first compliant transducer arrangement installed on the base member in serial relation to the first compliant transducer arrangement along the longitudinal axis of the base member. In addition, a first coupler element couples the inputs of the further first compliant transducer arrangement and the first compliant transducer arrangement to the first output portion of the actuator element.

The actuator element can be a piezoelectric element, a thermal actuator, an electric motor, an hydraulic system, etc.

In accordance with another apparatus aspect of the invention, there is provided a motion transducer, having a first base member, the base member having a longitudinal axis. A second base member is arranged in fixed relation to the first base member. Additionally, there is provided a first compliant transducer arrangement having a first compliant transducer structure installed in fixed relation to the first base member. The first compliant transducer structure has an input for receiving a first input displacement directed at a predetermined angle relative to the longitudinal axis of the first base member and an output for producing a first output force. There is additionally provided in this other aspect of the invention a second compliant transducer structure installed in fixed relation relative to the second base member. The second compliant transducer structure has an input for receiving the first output force from the first compliant transducer structure and an output for producing a second output force.

In one embodiment of this apparatus aspect of the invention, the second output force is directed substantially in opposition to the first input displacement. In other embodiments there is further provided a second compliant transducer arrangement having respectively associated ones of a first compliant transducer structure installed in fixed relation to the first base member, the first compliant transducer structure having an input for receiving a first input displacement directed at a predetermined angle relative to the longitudinal axis of the first base member and an output for producing a first output force. A second compliant transducer structure is installed in fixed relation relative to the second base member. The second compliant transducer structure has an input for receiving the first output force from the first compliant transducer structure and an output for producing a second output force. Additionally, a coupler couples the inputs of the first compliant transducer structures of the first and second compliant transducer arrangements.

In a further embodiment, there is further provided an actuator element having a first output portion coupled to the input of the first compliant transducer arrangement for producing the first input displacement, and a mounting portion for coupling to the first base member.

In accordance with a still further apparatus aspect of the invention, there is provided a motion transducer having a base member that has a longitudinal axis. An input element is arranged at a predetermined angle relative to the base element. Additionally, first and second compliant transducer arrangements each have a respectively associated first compliant transducer structure coupled to the base member. The first compliant transducer structure has an input for receiving a first input displacement directed at a predetermined angle relative to the longitudinal axis of the first base member and an output for producing a first output force, the input being coupled to the input element. Additionally, there is provided a second compliant transducer structure having a first input for receiving the first output force from the first respectively associated compliant transducer structure, a second input for coupling to the input element, and an output for producing a second output force.

In one embodiment of this still further aspect of the invention, there is further provided an actuator element having a first portion for coupling to the input element and a second portion for coupling in fixed relation to the base member. An output coupler couples the outputs of the second compliant transducer structures to each other.

In yet another apparatus aspect of the invention, there is provided a transducer system that has a compliant transducer structure having a predetermined response characteristic. The compliant transducer structure additionally has an input for receiving a mechanical input signal and an output for producing a corresponding mechanical output signal. The mechanical output signal is responsive to the mechanical input signal and to the predetermined response characteristic of the compliant transducer structure. An actuator has an input for receiving an electrical input signal, and an actuator output for coupling to the input of the compliant transducer structure. In addition, a load coupler arrangement is provided for coupling the output of the compliant transducer structure to a load.

There are a variety of application in which the invention herein described can be used. For example, the load coupler arrangement is in some embodiments configured to engage a control surface of an airfoil. In other embodiments, the load coupler arrangement is configured to engage an Active Boundary Layer Excitation (ABLE) System for an aircraft. Still further, the load coupler arrangement is configured to engage a body panel of a vehicle, or to engage a windscreen of a vehicle.

In a highly advantageous embodiment, the actuator element is a piezoelectric element, and the predetermined response characteristic of the compliant transducer structure includes a natural frequency determined by the relationship:

$$ω = 2 π f = \sqrt{\frac{{k}_{piezo}}{{GA}^{2} m}}$$

In other embodiments, the actuator element is an electric motor.

In accordance with a further apparatus aspect of the invention, there is provided an energy absorption system having a compliant transducer structure that is characterized with a predetermined response characteristic. The compliant transducer structure additionally has an input for receiving a mechanical input signal and an output for producing a corresponding mechanical output signal. The mechanical output signal is responsive to the mechanical input signal and to the predetermined response characteristic of the compliant transducer structure. In addition, there is provided a mechanical energy absorption arrangement coupled to the output of the compliant transducer structure for receiving the mechanical output signal.

In one embodiment of this further apparatus aspect of the invention, there is provided an input coupler arrangement for coupling the input of the compliant transducer structure to a source of mechanical energy.

In a further embodiment, the mechanical energy absorption arrangement is configured to convert the mechanical output signal into a corresponding electrical output signal.

There is further provided in some embodiments a compliant transducer structure having a predetermined response characteristic. The compliant transducer structure further has an input for receiving a mechanical input signal and an output for producing a corresponding mechanical output signal, the mechanical output signal being responsive to the mechanical input signal and to the predetermined response characteristic of the compliant transducer structure. An actuator is provided having an actuator input for receiving an input electrical input signal, and an actuator output for coupling to the input of the compliant transducer structure. In addition, a feedback arrangement provides in certain embodiments a correction electrical signal to the actuator input, the correction electrical signal being responsive to the corresponding electrical output signal of the mechanical energy absorption arrangement.

The mechanical energy absorption arrangement is, in some embodiments, a damper for converting the mechanical output signal into heat. A resilient material is, in some embodiments, installed to communicate with the compliant elements of the compliant transducer structure to facilitate the formulation of the energy absorption characteristic of the system.

In accordance with another apparatus aspect of the invention, there is provided a compliant transducer arrangement having a first compliant transducer structure that has a substantially planar triangular configuration with two legs joined to one another at an apex. The apex is configured to receive a mechanical input signal. There is additionally provided a second compliant transducer structure having a substantially planar U-shaped configuration that consists of two branches joined to one another at a bight of the U-shaped configuration. The second compliant transducer structure is arranged to surround the first compliant transducer structure in coplanar relation wherein the two branches of the second compliant transducer structure are coupled at their respective ends distal from the bight to respectively associated ones of the two legs of the first compliant transducer structure. The apex of the first compliant transducer structure being disposed between the two legs of the second compliant transducer structure.

In one embodiment of this apparatus aspect of the invention, there is provided a further compliant transducer arrangement. The compliant transducer arrangement and the further compliant transducer structure are disposed parallel to each other whereby the apex of the compliant transducer arrangement is directed toward the apex of the further compliant transducer arrangement. in addition, a coupling arrangement couples the compliant transducer arrangement and the further compliant transducer arrangement to each other.

In a further embodiment, the coupling arrangement consists of a first fastener for coupling the bight of the compliant transducer arrangement to the apex of the further compliant transducer arrangement, and a second fastener for coupling the bight of the further compliant transducer arrangement to the apex of the compliant transducer arrangement. The first and second fasteners are arranged in predetermined distal relationship to each other, a transmission ratio of the coupled compliant transducer arrangement and further compliant transducer arrangement being responsive to the predetermined distal relationship between the first and second fasteners.

An actuator is provided, the actuator having a first output arranged to communicate with the apex of the compliant transducer arrangement, and a second output arranged to communicate with the apex of the further compliant transducer arrangement. In a highly advantageous embodiment of the invention, the actuator is a piezoelectric actuator.

In general terms, an amplification device is one that amplifies (increases) either a displacement or force obtained from an input source. Preferably, the direction, or phase, of the output can be determined to be within 0-360 degrees. In the present invention, the amplification device is designed with a compliant topology, and one or more compliant elements function together to make the system operational.

As general objectives it is desired to design an amplifier that can easily be manufactured, while achieving minimum thickness variation and minimum overall complexity.

It is additionally desired to achieve good low-frequency performance. This is achieved, in accordance with the invention, by designing a higher amplification arrangement having a lower natural frequency, which results in better low-frequency performance. Minimization of the effect of lower-order modes will afford improved consistence of the response.

In the practice of the invention, the actuator that drives the amplification device can be any of a piezo-electric actuator, and electric motor, a solenoid, an hydraulic drive system, or any other actuator that can deliver force or displacement to the amplification device. In some embodiments of the invention, however, a passive component is used instead of an active component. in such embodiments, the amplification device is used to absorb energy.

Amplification devices of the type herein described have numerous applications, including without limitation, production of a surface vibration for improved flow over an airfoil surface; production of a surface vibration for eliminating ice that has formed on a wing; production of a surface vibration for acoustic purposes. Acoustic energy that has appropriately been phased can be used to dampen vibration of a surface. Also, an amplification device, as previously noted, can be loaded to absorb vibratory energy and thereby operate to isolate vibration, absorb energy, or otherwise function as a damper.

When applied to vibrate a surface, design characteristics and parameters that should be considered in the design of an amplification device include determination of the output force, output displacement, and frequency. Overall system frequency response will require determination of, and control over, system stiffness. The analysis, of course, requires that consideration be given to the input force, input displacement, and the frequency of the mechanical input signal. Also, package size, manufacturing methods, and material are evaluated with an eye toward minimizing power requirements and efficiency.

Manufacturing methods include, but are not limited to: extrusion, fine blanking (stamping), injection molding, casting, laser cutting, water jet cutting, EDM, and general machining. In embodiments of the invention formed of multiple parts, components can be stacked and welded (variable amplification at assembly).

The invention is suitable as an Active Boundary Layer Excitation (ABLE) system. In particular, the arrangement of the present invention is useful to improve flow quality for low-speed airfoils. For smaller and slower aircraft, the number that needs to be considered is the “Reynolds Number” (Re), which is a dimensionless number defined as:

$$Re = V \times \frac{I}{v}$$

where:
V=Relative speed (m/sec)
I=typical “length” of a solid body (M)
v=kinematic viscosity of air (sec/m²)

The kinematic viscosity is dependent upon the density of the air, but can be assumed to be constant for aircraft flying below 12,000 feet, i.e., equivalent to 15×10⁶ sec/m² (in metric).

The ABLE system decreases drag significantly by reducing the size of the laminar separation bubble. More specifically, drag is reduced by as much as 70% by vibrating a membrane on the upper surface of the leading edge. Vibrating the entire airfoil surface and not just a membrane on the leading edge may have a similar effect. A small energy input yields large aerodynamic benefit. By way of illustration, a 70 mW input to the ABLE system can yield a 70% aerodynamic improvement (i.e., reduced drag, increased lift, improved uniformity of lift over the airfoil's range of motion, greater aerodynamic efficiency, etc.). In this regard, testing was conducted at University of Illinois Urbana-Champagne on a 12″ chord, 36″ span model, at Reynolds numbers of 60,000, 100,000, and 200,000.

From the standpoint of the manufacture of the compliant systems of the present invention, it is noted that the use of extrusion as a manufacturing technique yields good mechanical properties and a good surface finish. Additionally, the resulting product exhibits no oxidation and possesses high dimensional accuracy. In the practice of some embodiments of the invention, aluminum 2024 is targeted, with a minimum thickness of approximately 1 mm and a minimum corner/fillet of approximately 0.4 mm.

### BRIEF DESCRIPTION OF THE DRAWING

Comprehension of the invention is facilitated by reading the following detailed description, in conjunction with the annexed drawing, in which:

FIG. 1 is a schematic illustration of a prior art triangular element forming the base structure of the present invention;

FIG. 2 is a schematic illustration of a plurality of the prior art structures seen in FIG. 1 being utilized in conjunction with one another and arranged to form a displacement amplifying device;

FIG. 3 is a schematic illustration of a prior art device incorporated with a linear actuator to provide amplified linear output;

FIG. 4 schematically illustrates a prior art device formed of a series of known structures;

FIG. 5 is a simplified schematic representation showing a plan view of a specific illustrative embodiment of the invention having a piezoelectric actuator and symmetrical outputs;

FIG. 6 is an isometric representation of the embodiment of FIG. 5;

FIG. 7 is a simplified schematic representation showing a plan view of a further specific illustrative embodiment of the invention having a piezoelectric actuator and symmetrical outputs;

FIG. 8 is an isometric representation of the embodiment of FIG. 7;

FIG. 9 is an isometric representation of a specific illustrative embodiment of the invention wherein multiple transducer elements share a single piezoelectric actuator;

FIG. 10a is a simplified schematic representation of a single output transducer element that employs a piezoelectric actuator, and FIG. 10b is an isometric representation of the embodiment of FIG. 10a;

FIG. 11 is an isometric representation of a further specific illustrative embodiment of the invention wherein multiple transducer elements share a single piezoelectric actuator;

FIG. 12 is a simplified schematic representation of a dual output transducer element that employs a piezoelectric actuator;

FIG. 13 is an isometric representation of the embodiment of the embodiment of FIG. 12, with the outputs bridged;

FIG. 14 is a simplified schematic representation of the embodiment of FIG. 12, showing certain dimensional values;

FIG. 15 is an isometric representation of a dual output embodiment that employs a single piezoelectric actuator;

FIG. 16 is an isometric representation of the dual output embodiment of FIG. 16 further showing the outputs to be bridged;

FIG. 17 is a partially exploded isometric representation of the dual output embodiment of FIG. 16;

FIGS. 18(a), 18(b), and 18(c) are simplified isometric schematic representations of a specific illustrative embodiment of the invention, showing respective locations of an effective pivot to achieve respective operating ratios;

FIGS. 19(a), 19(b), and 19(c) are simplified schematic representations of the transducers shown in FIGS. 18(a), 18(b), and 18(c), respectively, an showing the respective transmission ratios;

FIG. 20 is a simplified schematic representation of a specific illustrative embodiment of the invention having plural outputs and a single input piezoelectric actuator with an anti-rotation feature;

FIG. 21 is a perspective representation of an embodiment if the invention shown attached to the underside of an airfoil for causing vibratory motion to be applied to the underside of an airfoil;

FIG. 22 is a graphical representation of and airfoil (Eppler 387) that is useful to describe the active surface and a laminar bubble region;

FIG. 23 is a graphical representation that correlates for illustrative purposes the beneficial operating characteristics of the Active Boundary Layer Excitation System (ABLE); and

FIG. 24 is a table that correlates Alpha against a corresponding percentage reduction in the coefficient of friction Cd.

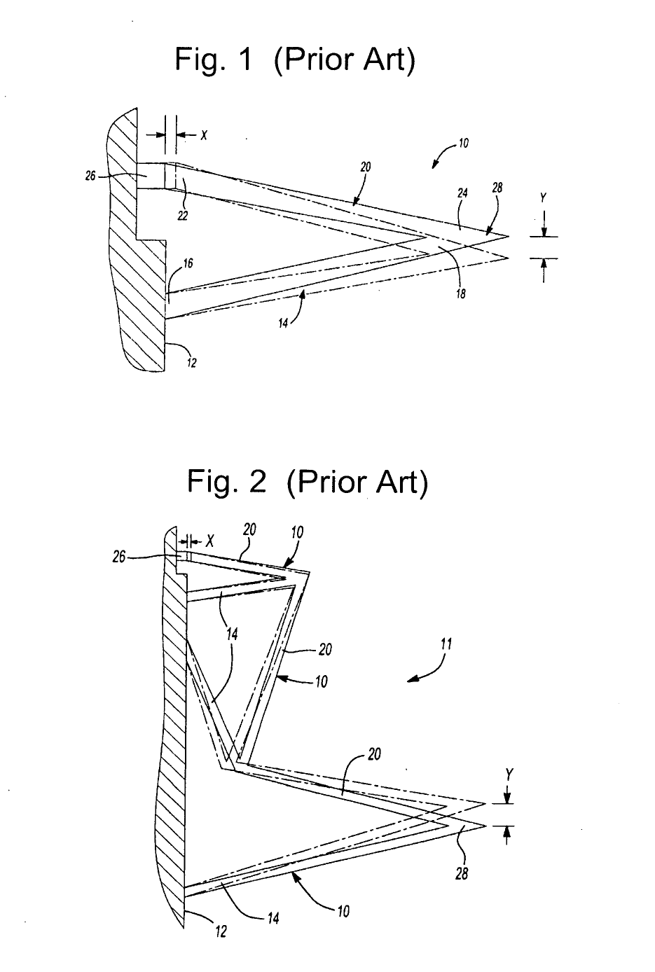

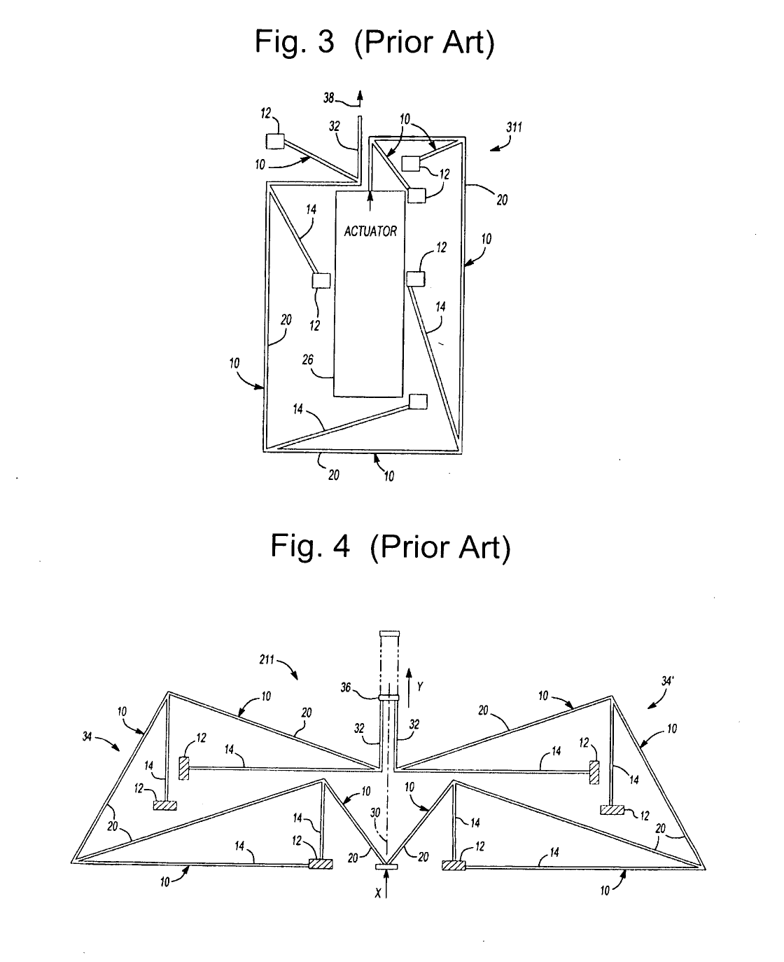

### DETAILED DESCRIPTION

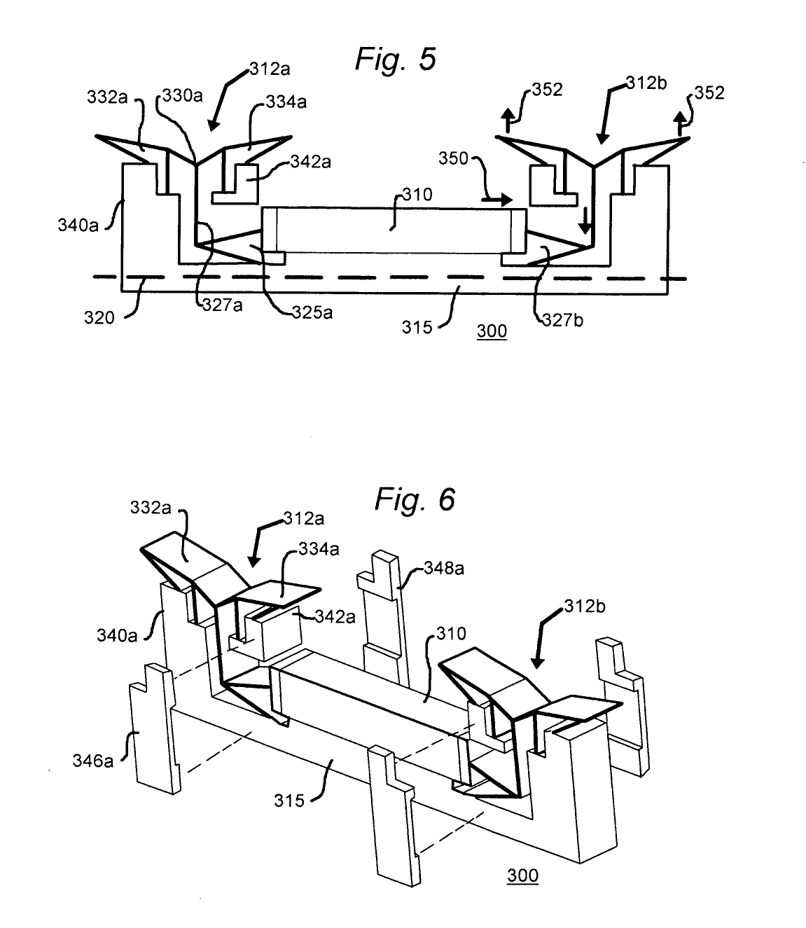

FIG. 5 is a simplified schematic representation showing a plan view of a specific illustrative embodiment of a compliant transducer arrangement 300 having a piezoelectric actuator 310 and symmetrical outputs 312a and 312b. FIG. 6 is an isometric representation of compliant transducer arrangement 300 shown in FIG. 5. As shown in these figures, compliant transducer arrangement 300 has a base 315 on which is installed piezoelectric actuator 310. The piezoelectric actuator is, in this specific illustrative embodiment of the invention, mounted longitudinally parallel to longitudinal axis 320 of base 315.

In this specific illustrative embodiment of the invention, symmetrical outputs 312a and 312b of compliant transducer arrangement 300 are mirror images of each other, and therefore the supporting structure of only symmetrical output 312a will be described in detail. As seen in FIG. 5, piezoelectric actuator 310 is coupled at its output to a compliant transducer structure 325a that is coupled at a second leg thereof to base 315. Compliant transducer structure 325a is coupled at its output to a compliant element 327a that is coupled to a node 330a. Node 330a constitutes the juncture of compliant transducer structures 332a and 334a. Compliant transducer structures 332a and 334a have respective outputs that combine to form symmetrical output 312a.

It is noteworthy that symmetrical output 312a employs three levels of grounding at five ground points (not specifically designated). As shown, compliant transducer structure 325a is grounded to base 315. In addition, compliant transducer structures 332a and 334a are grounded to elevated bases 340a and 342a, each of which elevated bases, in this specific illustrative embodiment of the invention, has two grounding levels (not specifically designated).

Referring to FIG. 6, elevated base 342a is supported by stanchions 346a and 348a. Stanchions 346a and 348a are coupled by fasteners (not shown) to base 315 and to elevated base 342a. Elevated base 340a is formed, as shown, by a stanchion that is formed, in this specific illustrative embodiment of the invention, integrally with base 315.

From the standpoint of direction of operation, it is seen in FIG. 5 that outward displacement of piezoelectric actuator 310 causes symmetrical outputs 312a and 312b to move upward. In this figure, the outward displacement of the piezoelectric actuator is represented by arrow 350, and the corresponding upward displacement of symmetrical outputs 312a and 312b is represented by arrows 352. As piezoelectric actuator 310 is urged outwardly, compliant element 327b is drawn downward. Of course, when piezoelectric actuator 310 contracts (i.e., in the direction opposite to that represented by arrow 350), all of the directions shown by the arrows are reversed.

An advantage of compliant transducer arrangement 300 is that it affords an adequate number of output contact points to distribute loads and stress. In addition, this embodiment of the invention can readily be manufactured by extrusion process. The foregoing notwithstanding, this compliant transducer arrangement requires some assembly. Manufacturing of this embodiment is also feasible with the use of die casting, forging, etc. It can be fabricated from aluminum, steel, titanium, plastics, composites, etc.

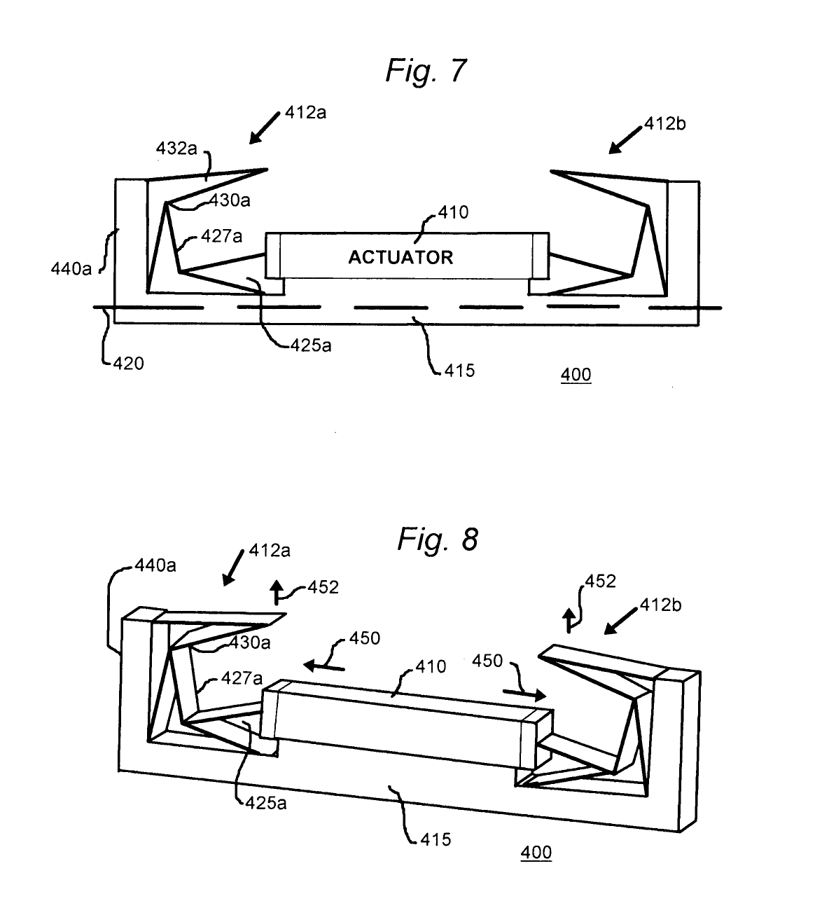

FIG. 7 is a simplified schematic representation showing a plan view of a compliant transducer arrangement 400 having a piezoelectric actuator 410 and symmetrical outputs 412a and 412b. FIG. 8 is an isometric representation of compliant transducer arrangement 400. As shown in these figures, compliant transducer arrangement 400 has a base 415 on which is installed piezoelectric actuator 410. The piezoelectric actuator is, in this specific illustrative embodiment of the invention, mounted longitudinally parallel to longitudinal axis 420 of base 415.

In this specific illustrative embodiment of the invention, symmetrical outputs 412a and 412b of compliant transducer arrangement 400 are mirror images of each other, and therefore the supporting structure of only symmetrical output 412a will be described in detail. As seen in FIG. 7, piezoelectric actuator 410 is coupled at its output to a compliant transducer structure 425a that is coupled at a second leg thereof to base 415. Compliant transducer structure 425 is coupled at its output to a compliant element 427a that is coupled to a node 430a. Node 430a constitutes the juncture with compliant transducer structure 432a. Compliant transducer structure 432a has an output that forms symmetrical output 412a.

From the standpoint of direction of operation, it is seen in FIG. 8 that outward displacement of piezoelectric actuator 410 causes symmetrical outputs 412a and 412b to move upward. In this figure, the outward displacement of the piezoelectric actuator is represented by arrows 450, and the corresponding upward displacement of symmetrical outputs 412a and 412b is represented by arrows 452. Of course, when piezoelectric actuator 410 contracts (i.e., in the direction opposite to that represented by arrows 450), all of the directions shown by the arrows are reversed.

An advantage of compliant transducer arrangement 400 is that it affords an adequate number of output contact points to distribute loads and stress. In addition, this embodiment of the invention can readily be manufactured by extrusion process. The foregoing notwithstanding, this compliant transducer arrangement requires some assembly. Manufacturing of this embodiment is also feasible with the use of die casting, forging, etc. It can be fabricated from aluminum, steel, titanium, plastics, composites, etc.

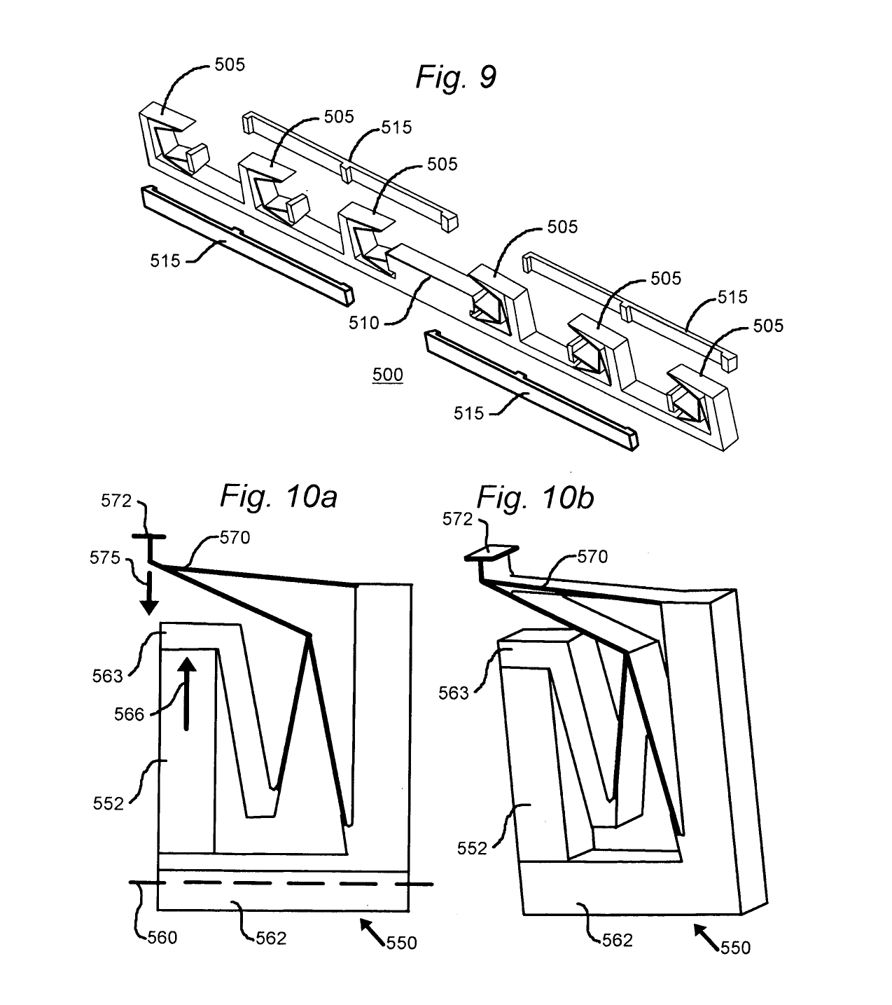

FIG. 9 is a partially exploded isometric representation of a linear array 500 of compliant transducer arrangements 505, wherein multiple ones of the compliant transducer arrangements share a single piezoelectric actuator 510. As shown in this figure, the outputs of compliant transducer arrangements 505 are coupled to each other by output couplers 515.

FIGS. 10a and 10b, illustrate the details of a compliant transducer arrangement 550, wherein FIG. 10a is a simplified schematic representation of a compliant transducer arrangement 550 that employs a piezoelectric actuator 552, and FIG. 10b is an isometric representation compliant transducer arrangement 550. Elements of structure that have previously been discussed are similarly designated in this figure. As shown, piezoelectric actuator 552 is disposed substantially orthogonal to longitudinal axis 560 of base 562.

In operation, as piezoelectric actuator 552 is urged upward toward input 563 in the direction of arrow 566, output 570, which is provided with an output coupler 572, is urged downward, as represented by arrow 575.

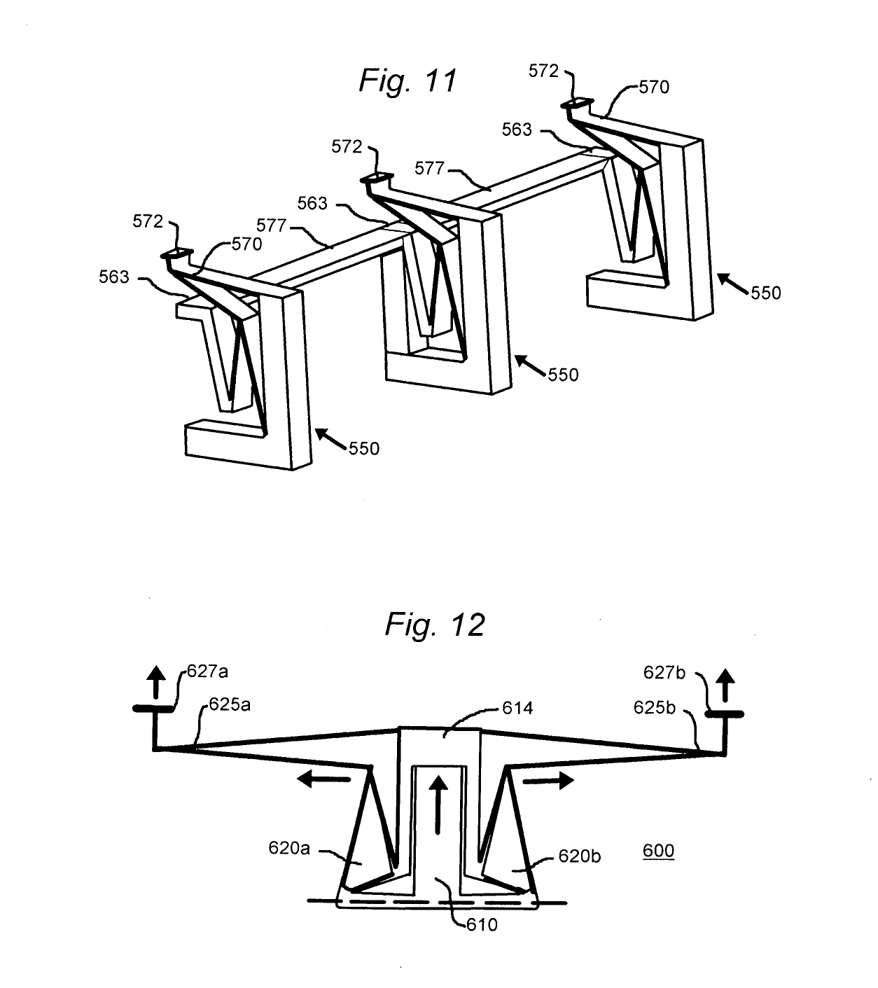

FIG. 11 is an isometric representation of a further specific illustrative embodiment of the invention wherein multiple compliant transducer arrangements 550 share a single piezoelectric actuator 552. The inputs 563 of multiple compliant transducer arrangements 550 are coupled to one another by a coupler arrangement 577.

It is an advantage of this embodiment of the invention that a relatively small piezoelectric actuator can be utilized, and full piezo displacement is afforded. Additionally, the piezoelectric actuator does not float, and the compliant transducer arrangement can readily be extruded. limitations are that some assembly is required, and the arrangement requires an overall height that typically is in excess of 20 mm.

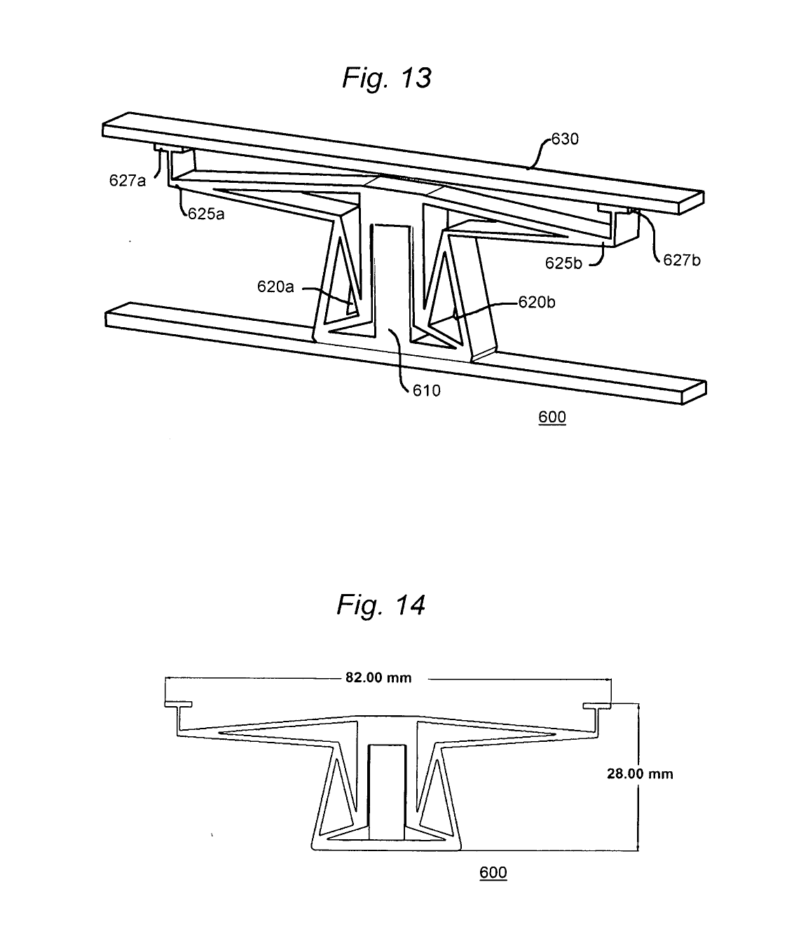

FIG. 12 is a simplified schematic representation of a dual output transducer element 600 that employs a piezoelectric actuator 610. FIG. 13 is an isometric representation of dual output transducer element 600 shown in FIG. 12, with the outputs bridged by an output coupler 630, and FIG. 14 is a simplified schematic representation of dual output transducer element 600 showing certain dimensional values. Elements of structure are similarly designated in these figures.

Referring to FIG. 12, dual output transducer element 600 has an input 614 that communicates with piezoelectric actuator 610. The piezoelectric actuator is shown to be disposed orthogonal to the axis (not specifically designated) of the base (not specifically designated). On each side of piezoelectric actuator 610 is disposed one of triangular compliant transducer structures 620a and 620b. The outputs of dual output transducer element 600 are designated 625a and 625b, and are each provided with a respective one of output couplers 627a and 627b. Overall amplification is effected by the combination of the direct displacement of input 614 by piezoelectric actuator 610 and the amplification produced by operation of compliant transducer structures 620a and 620b.

FIG. 14 shows certain dimensions of dual output transducer element 600. Specifically, this specific illustrative embodiment of the invention, is 82.00 mm long by 28.00 mm high.

It is an advantage of dual output transducer element 600 that a relatively small piezo is used and full piezo displacement is afforded. Additionally, the piezoelectric actuator does not float. Fewer members are required in each unit cell, and manufacturing can be effected by extrusion process. No significant assembly is required. This arrangement, however, provides only two support points for the load, but that may be adequate for most applications.

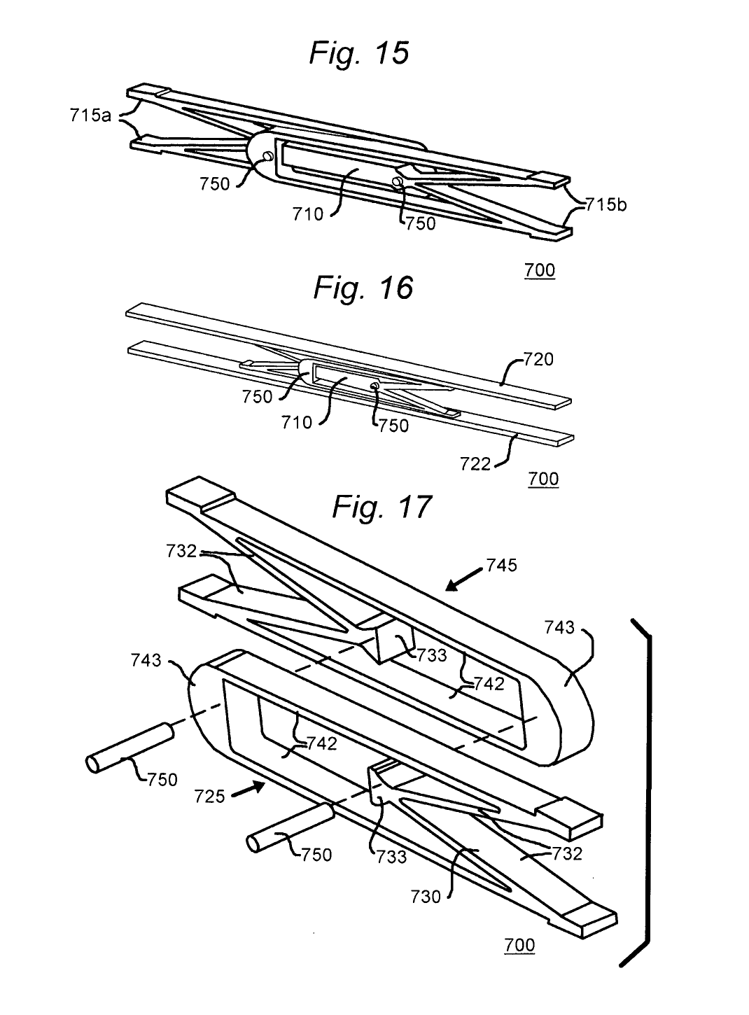

FIG. 15 is an isometric representation of a dual output compliant transducer arrangement 700 that employs a single piezoelectric actuator 710. FIG. 16 is an isometric representation of dual output compliant transducer arrangement 700, further showing outputs to be bridged by output couplers 720 and 722. FIG. 17 is a partially exploded isometric representation of the dual output compliant transducer arrangement 700.

As shown in these figures, dual output compliant transducer arrangement 700 has a compliant transducer arrangement 725 having a first compliant transducer structure 730 having a substantially planar triangular configuration with two legs 732 joined to one another at an apex 733. The apex is configured to receive a mechanical input signal from piezoelectric actuator 710. There is additionally shown a second compliant transducer structure 740 having a substantially planar U-shaped configuration with two branches 742 joined to one another at a bight 743 of the U-shaped configuration. Second compliant transducer structure 740 is arranged to surround first compliant transducer structure 730 in coplanar relation wherein the two branches 742 of second compliant transducer structure 740 are coupled at their respective ends distal from bight 743 to respectively associated ones of legs 732 of first compliant transducer structure 730. The apex of first compliant transducer structure 730 is disposed between the branches of second compliant transducer structure 740.

The figures additionally show that there are two compliant transducer arrangements, specifically compliant transducer arrangement 725 and further compliant transducer arrangement 745. The elements of structure of further compliant transducer arrangement 745 are designated with correspondence to those of compliant transducer arrangement 725. Compliant transducer arrangement 725 and further compliant transducer arrangement 745 are disposed parallel to each other whereby apex 733 of compliant transducer arrangement 725 is disposed to be directed toward apex 733 of further compliant transducer arrangement 745.

Fasteners 750 for coupling the bight of the compliant transducer arrangement to the apex of the further compliant transducer arrangement, and the bight of the further compliant transducer arrangement to the apex of the compliant transducer arrangement. Actuator 710, which may be a piezoelectric actuator, is arranged to communicate with the apex of the compliant transducer arrangement, and that of the further compliant transducer arrangement.

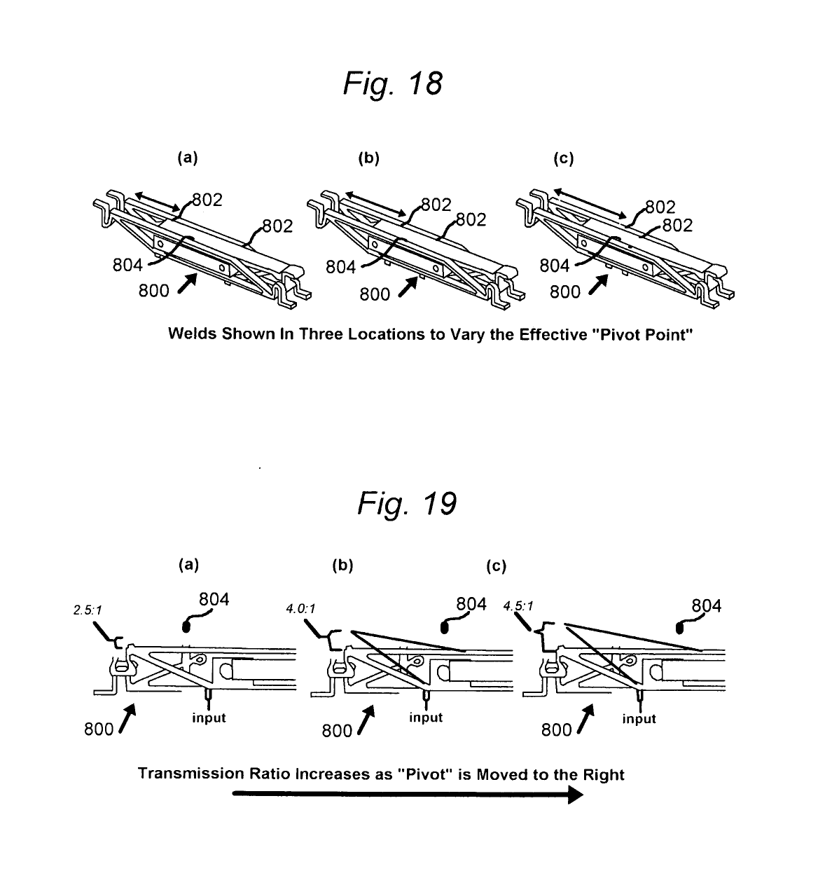

FIGS. 18(a), 18(b), and 18(c) are simplified isometric schematic representations of a compliant transducer 800, showing respective locations of welds 802 to modify an effective pivot point 804 and thereby achieve respective operating ratios. FIGS. 19(a), 19(b), and 19(c) are simplified schematic representations of the transducers shown in FIGS. 18(a), 18(b), and 18(c), respectively, an showing the respective transmission ratios and the sequential shift of the effective pivot point toward the right as the spacing between welds 802 is altered. More specifically, in this specific illustrative embodiment of the invention, the configuration of FIGS. 18(a)/19(a) achieves a transmission ratio of 2.5:1; the configuration of FIGS. 18(b)/19(b) achieves a transmission ratio of 4.0:1; and the configuration of FIGS. 18(c)/19(c) achieves a transmission ratio of 4.5:1.

It is an advantage of the embodiment of FIGS. 18 and 19 that full piezo displacement is achieved. Also, fewer member in the unit points cells are required and the devices can be fabricated using extrusion process. However, some assembly is required, and only two support points are provided, which may be adequate for most applications.

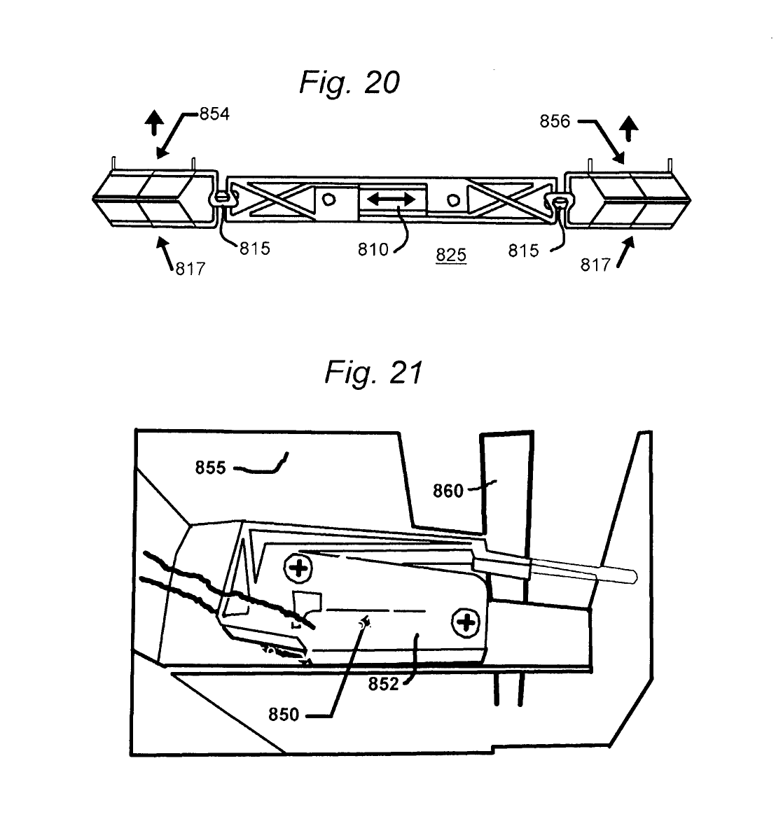

FIG. 20 is a simplified schematic representation of a specific illustrative compliant transducer arrangement 825 having plural outputs 854 and 856. A single input piezoelectric actuator 810 is employed, and there is additionally provided an anti-rotation feature 815 at each output. It is an object of this specific illustrative embodiment of the invention to minimize rotation of a surfaces (not shown) acted upon by the compliant transducer arrangement and thereby enforce parallel motion. Additionally, low extensional stiffness of the anti-rotation feature is desired to minimize retardation of the motion. These objectives are achieved by employing parallel linkage mechanisms 817 as the actuator ends.

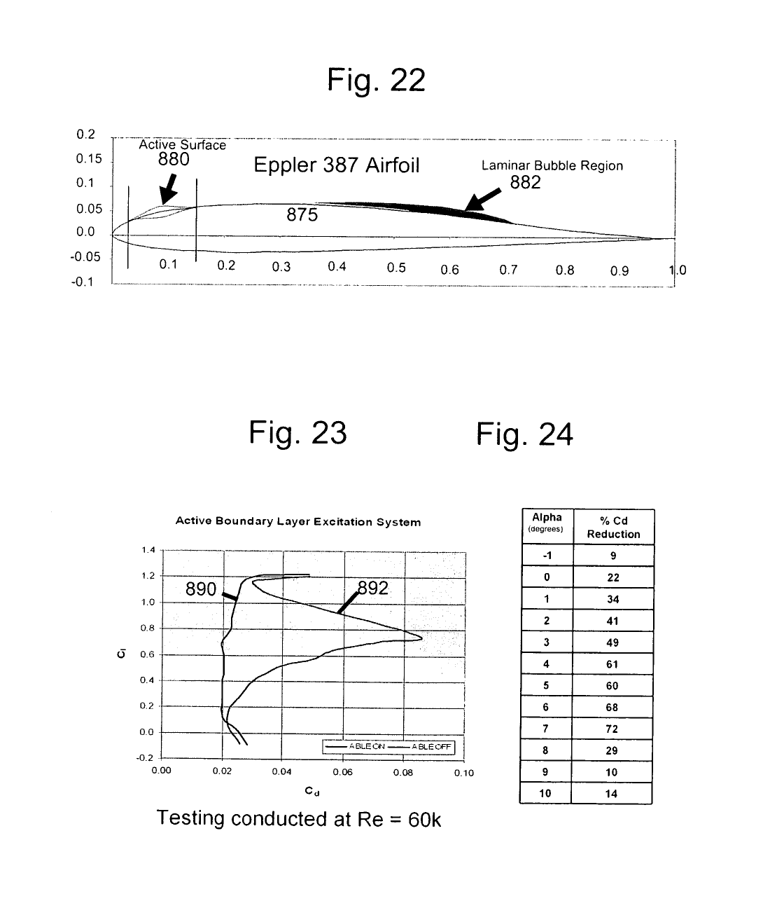

FIG. 21 is a perspective representation of a compliant transducer arrangement 850, with a piezoelectric actuator 852, shown attached to the underside of an airfoil 855 for causing vibratory motion to be applied to the underside of the airfoil. The output of compliant transducer arrangement 850 is, in this specific illustrative embodiment of the invention, coupled directly to an Active Boundary Layer Excitation (ABLE) system 860. This system is useful in low Re airfoils (50,000 to 300,000) to reduce the effect of the laminar bubble, as will be illustrated below with respect to FIG. 22.

FIG. 22 is a graphical representation of and airfoil 875 (Eppler 387) that is useful to illustrate an active surface 880 and a laminar bubble region 882. It is to be noted that the vibrating surface does not itself produce laminar flow, as the laminar flow is already present. Instead, the device sends “energy waves” (not shown) tumbling down the airfoil near the boundary layer (not shown) and when the energy waves reach laminar bubble region 882, the air flow is made more normal and the laminar bubble is reduced, if not eliminated. It may be possible that subjecting the entire airfoil to a vibration would achieve the same result.

FIG. 23 is a graphical representation that correlates for illustrative purposes the beneficial operating characteristics of the Active Boundary Layer Excitation (ABLE) system. The graph plots CI (Coefficient of Lift) on the y-axis, and Cd (Coefficient of Drag) on the x-axis. These values are non-dimensional and are used in equations for calculating airfoil lift and drag depending on the airspeed, air density, and airfoil size (surface area). As shown in this figure, graphical plot 890 illustrates the drag coefficient Cd with the ABLE system in operation, and graphical plot 892 illustrates the drag coefficient Cd without the ABLE system. The testing that resulted in this graph was made at Re=60,000, and it is seen that operation of the ABLE system clearly reduces Cd.

FIG. 24 is a table that correlates Alpha (angle of attack or pitch of the wing) against a corresponding percentage reduction in the coefficient of friction Cd. The units of alpha is degrees.

In embodiments of the invention where piezoelectric actuators are employed, the following analysis aids in defining a system design:

$${na}_{↓} tural frequency \\ 2 π f = \sqrt{\frac{{k}_{piezo}}{{GA}^{2} m}} \} \begin{matrix}amplifier design and chosen \\ piezo affect system linearity\end{matrix} \\ F = m {ω}^{2} d \\ \begin{matrix}{F}_{piezo} = \frac{F}{MA} \\ {d}_{piezo} = \frac{d}{GA}\end{matrix} \} \begin{matrix}amplifier design determines \\ required piezo\end{matrix}$$

$$η = \frac{F \times GA}{{F}_{piezo}} \\$$

(η has a value of between 0 and 1, where 1 is ideal, and is a measure of strain energy stored in the amplifier versus strain energy stored in the piezo under loaded conditions)

$${F}_{piezo} = \frac{F \times GA}{η}$$

where:
f is frequency
k_{piezo} is piezoelectric stiffness
GA is Geometric Advantage
MA is Mechanical Advantage
m is mobile mass (can neglect actuator mass if driven mass is significantly larger than the “mobile” equivalent mass of the actuator)
2πf (or ω) is the natural frequency for a single degree of freedom system, or an approximation of first natural frequency for multiple degree of freedom system
d is free displacement from piezo amplifier
F_{piezo} is blocked force of piezo at voltage condition of interest
F is blocked force from piezo amplifier
d_{piezo} is free displacement of piezo at voltage condition of interest
d is free displacement from piezo amplifier
η is structural efficiency (introduced to eliminate MA from the nomenclature)

Although the invention has been described in terms of specific embodiments and applications, persons skilled in the art may, in light of this teaching, generate additional embodiments without exceeding the scope or departing from the spirit of the invention described and claimed herein. Accordingly, it is to be understood that the drawing and description in this disclosure are proffered to facilitate comprehension of the invention, and should not be construed to limit the scope thereof.

What is claimed is:

1. A motion transducer, comprising:
a base member, said base member having a longitudinal axis;
a first compliant transducer arrangement installed on said base member, said first compliant transducer arrangement having an input for receiving a first vibratory input displacement directed substantially parallel to the longitudinal axis of said base member and an output for producing a first vibratory output force directed at a predetermined angle with respect to the longitudinal axis of said base member; and
a vibratory actuator element having a first output portion coupled to the input of said first compliant transducer arrangement for producing the first vibratory input displacement.

2. The motion transducer of claim 42, wherein there is further provided a second compliant transducer arrangement installed on said base member, said second compliant transducer arrangement having an input for receiving a second vibratory input displacement and an output for producing an output force directed at a further predetermined angle with respect to the longitudinal axis of said base member, said vibratory actuator element having a second output portion coupled to the input of said second compliant transducer arrangement for producing the second vibratory input displacement.

3. The motion transducer of claim 1, wherein said first compliant transducer arrangement is formed of first and second triangular structures, there being provided a further base member displaced from said base member for coupling to said first triangular structure of said first compliant transducer arrangement.

4. The motion transducer of claim 1, wherein there is provided a further first compliant transducer arrangement installed on said base member in serial relation to said first compliant transducer arrangement along the longitudinal axis of said base member, and there is further provided a first coupler element for coupling the inputs of said further first compliant transducer arrangement and said first compliant transducer arrangement to the first output portion of said vibratory actuator element.

5. The motion transducer of claim 1, wherein said vibratory actuator element is selected from a group of vibratory actuator elements, the group of vibratory actuator elements comprising a piezoelectric element, a thermal actuator, an electric motor, and an hydraulic system.

6. The motion transducer of claim 1, wherein there is further provided:
a second base member arranged in fixed relation to said first base member; and
said first compliant transducer arrangement is additionally provided with:
a second compliant transducer structure installed in fixed relation relative to said second base member, said second compliant transducer structure having an input for receiving the first vibratory output force from said first compliant transducer structure and an output for producing a second output force.

7. The motion transducer of claim 6, wherein there is further provided:
a second compliant transducer arrangement having:
a first compliant transducer structure installed in fixed relation to said first base member, said first compliant transducer structure having an input for receiving a first input displacement directed at a predetermined angle relative to the longitudinal axis of said first base member and an output for producing a first output force; and
a second compliant transducer structure installed in fixed relation relative to said second base member, said second compliant transducer structure having an input for receiving the first output force from said first compliant transducer structure and an output for producing a second output force; and
a coupler for coupling the inputs of said first compliant transducer structures of said first and second compliant transducer arrangements.

8. The motion transducer of claim 1, further comprising:
an input element arranged at a predetermined angle relative to said base element; and
a second compliant transducer arrangement;
wherein each of said first and second compliant transducer arrangements is provided with;
a respectively associated first compliant transducer structure coupled to said base member, said first compliant transducer structure having an input for receiving a first input displacement directed at a predetermined angle relative to the longitudinal axis of said first base member and an output for producing a first output force, the input being coupled to said input element; and
a second compliant transducer structure having a first input for receiving the first output force from said first respectively associated compliant transducer structure, a second input for coupling to said input element, and an output for producing a second output force.

9. The motion transducer of claim 8, wherein there is further provided a vibratory actuator element having a first portion for coupling to said input element and a second portion for coupling in fixed relation to said base member.

10. The motion transducer of claim 8, wherein there is further provided an output coupler for coupling the outputs of said second compliant transducer structures to each other.

11. The motion transducer of claim 1, further comprising a load coupler arrangement for coupling the output of said compliant transducer structure to a load.

12. The transducer system of claim 11, wherein said load coupler arrangement is configured to engage a selectable one of a control surface of an airfoil and an Active Boundary Layer.

13. The transducer system of claim 11, wherein said vibratory actuator element is a piezoelectric element, and the predetermined response characteristic of said compliant transducer structure includes a natural frequency determined by the relationship:
$$ω = 2 π f = \sqrt{\frac{{k}_{piezo}}{{GA}^{2} m}}$$

14. An energy absorption system comprising:
a compliant transducer structure having a predetermined response characteristic, said compliant transducer structure further having an input for receiving a vibratory mechanical input signal and an output for producing a corresponding vibratory mechanical output signal, the vibratory mechanical output signal being responsive to the vibratory mechanical input signal and to the predetermined response characteristic of said compliant transducer structure; and
a mechanical energy absorption arrangement coupled to the output of said compliant transducer structure for receiving the vibratory mechanical output signal.

15. The energy absorption system of claim 14, wherein said mechanical energy absorption arrangement is configured to convert the mechanical output signal into a corresponding electrical output signal.

16. The energy absorption system of claim 15, wherein there is further provided:
a compliant transducer structure having a predetermined response characteristic, said compliant transducer structure further having an input for receiving a vibratory mechanical input signal and an output for producing a corresponding vibratory mechanical output signal, the vibratory mechanical output signal being responsive to the vibratory mechanical input signal and to the predetermined response characteristic of said compliant transducer structure;
an actuator having an actuator input for receiving an input electrical input signal, and an actuator output for coupling to the input of said compliant transducer structure; and
a feedback arrangement for providing a correction electrical signal to the actuator input, said correction electrical signal being responsive to the corresponding electrical output signal of said mechanical energy absorption arrangement.

17. The energy absorption system of claim 14, wherein said mechanical energy absorption arrangement is a damper for converting the vibratory mechanical output signal into heat.

18. The energy absorption system of claim 14, wherein there is further provided a resilient damping material installed to communicate with compliant elements of said compliant transducer structure.

19. A transducer system, comprising:
a compliant transducer arrangement having:
a first compliant transducer structure having a substantially planar triangular configuration with first and second legs joined at respective proximal ends thereof to one another at an apex, the apex being configured to receive a vibratory mechanical input signal; and
a second compliant transducer structure having a substantially planar U-shaped configuration with first and second branches joined at respective proximal ends thereof to one another at a bight of the U-shaped configuration,
wherein said second compliant transducer structure is arranged to surround said first compliant transducer structure in coplanar relation wherein the first and second branches of said second compliant transducer structure are coupled at respectively associated distal ends thereof to respectively associated distal ends of the first and second legs of said first compliant transducer structure, the apex of said first compliant transducer structure being disposed between the two branches of said second compliant transducer structure.

20. The transducer system of claim 19, wherein there is provided:
a further compliant transducer arrangement having a further first compliant transducer structure and a further second compliant transducer structure, said compliant transducer arrangement and said further compliant transducer structure being disposed parallel to each other whereby the apex of said first compliant transducer structure is disposed to be directed toward the apex of said further first compliant transducer structure;
a first fastener for coupling the bight of said compliant transducer arrangement to the apex of said further first compliant transducer structure; and
a second fastener for coupling the bight of said further compliant transducer arrangement to the apex of said first compliant transducer structure.
